(19) United States
(12) Patent Application Publication
(10) Pub. No.: US 2005/0267630 A1
(43) Pub. Date: Dec. 1, 2005

(54) Walking gait producing device for walking robot

(76) Inventors: Shuuji Kajita, Ibaraki (JP); Fumio Kanehiro, Ibaraki (JP); Kenji Kaneko, Ibaraki (JP); Kiyoshi Fujiwara, Ibaraki (JP); Kensuke Harada, Ibaraki (JP); Kazuhito Yokoi, Ibaraki (JP); Hirohisa Hirukawa, Ibaraki (JP)

Correspondence Address: MORGAN LEWIS & BOCKIUS LLP, 1111 PENNSYLVANIA AVENUE NW, WASHINGTON, DC, 20004, US

(21) Appl. No.: 10/529,252

(22) PCT Filed: Sep. 17, 2003
(86) PCT No.: PCT/JP03/11842

§ 371 Date: Mar. 25, 2005

(30) Foreign Application Priority Data
Sep. 26, 2002 (JP) 2002-281656

(51) Int. Cl. G06F 19/00

(52) U.S. Cl. 700/245

(57) ABSTRACT

An object of the present invention is to provide a gait pattern generating device by which a gait pattern of a robot such as a humanoid bipedal walking robot having a structure easy to fall down can be generated easily in real time. This device calculates a driving quantity of the center of gravity in one moment using a preview control method based on feedback of the motion state of the center of gravity in that moment, and feed-forward of a future ZMP trajectory up to a few seconds from that moment. Next, the robot is driven to obtain the obtained center-of-gravity trajectory. Thus, a walking motion is attained.

### FIELD OF THE INVENTION

The present invention relates to a behavior generating device of a bipedal walking robot, a humanoid robot or the like, and particularly relates to a gait pattern generating device of a walking robot for generating a walking motion in real timer for example, using a previewed or planned future zero-moment point (also referred to as “ZMP” in this description) which will be obtained in a few seconds from now.

### BACKGROUND ART

In order to explain the background art in a way easy to understand, description will be made first about a “table-cart model” in which the characteristic of a robot is simplified.

FIG. 9 shows an example of a bipedal walking robot aimed at by the present invention. The robot is not limited to such a humanoid robot, but the robot may be formed into various shapes such as a bird-like shape, a dinosaur-like shape, etc. if it has two legs.

The technical problem of such a robot lies in the fact that the center-of-gravity position of the robot exists in a high position in spite of a small area of its sole so that the robot may fall down very easily particularly when the robot supports its body on one leg.

The dynamics of such a bipedal walking robot is expressed by a complicated equation of motion, but its rough behavior can be approximated by a table-cart model as shown in FIG. 10. This is a model in which a cart having mass M runs horizontally on a table whose mass is negligible. In this model, the pedestal of the table is so narrow in comparison with the running range of the cart that the cart as a whole will fall down when the cart reaches an end of the table.

That is, in this model, the horizontal displacement of the center of gravity of the bipedal walking robot is replaced by the cart, and foot portions of support legs are replaced by support portions of the table. Zₕ designates the height of the center of gravity from the floor surface, and x designates the horizontal displacement of the center of gravity. Since the center-of-gravity position of the robot substantially coincides with the waist thereof, the motion of the cart can be regarded as consistent with the motion of the waist.

Incidentally, the robot walks three-dimensionally. It is therefore necessary to imagine table-cart models respectively for a motion in the traveling direction and a motion in the left/right direction. However, these models may be dealt with independently of each other. Therefore, the following description will be made about one model.

Now, when the cart is running toward an edge of the table at an appropriate accelerated rate, the cart can be prevented from falling down. In this event, in one point in the plane where the pedestal abuts against the floor surface, there exists a point where the moment acting from the floor surface becomes zero, that is, a zero-moment point (ZMP).

The following Expression 1 is established based on the definition of the ZMP when p designates the position of the ZMP and τ_{ZMP} designates the moment around the ZMP.
τ_{ZMP}=Mg(x−p)−Mx″Zₕ=0 (1)

It is understood that the position of the ZMP can be obtained by the following Expression 2 when Expression 1 is transformed.

$$p = x - \frac{{z}_{h}}{g} {x}^{″} \qquad ( 2 )$$

From this expression, a motion p(t) of the ZMP can be calculated easily on a given motion pattern x(t) of the cart.

To generate a walking pattern is to obtain a motion of the center of gravity attaining a desired ZMP trajectory depending on the landing position of each leg or the like, from the desired ZMP trajectory. In the background art, the following two methods have been known as methods for calculating the motion.

(1) A method in which a desired ZMP pattern is transformed by Fourier series so as to solve Expression 2 in the frequency domain, and an obtained result is transformed by inverse Fourier series so as to calculate a motion pattern of the center of gravity (for example, see Takanishi; Biped Walking Robot Compensating Moment by Trunk Motion, Journal of the Robotics Society of Japan, Vol. 11, No. 3, pp. 348-353 (1993)) (hereinafter referred to as “Background-Art Technique 1”).

(2) A method in which a three-term equation obtained by discretization of Expression 2 is solved so that a motion of the center of gravity attaining a desired ZMP can be calculated easily and at a high speed (for example, Nishiwaki, Kitagawa, Sugihara, Kagami, et al.: Fast Generation of a Dynamically Stable Trajectory of Humanoid with Linear Decoupling and Discretization of ZMP Derivation—attained in Perception-Action Integrated Whole-Body Humanoid H6, The 18th Annual Conference of the Robotics Society of Japan, pp. 721-72 (2000)) (hereinafter referred to as “Background-Art Technique 2”).

(3) A method in which typical walking motions are calculated in advance, and the motions are combined to generate stable walking in real time (for example, see the Unexamined Japanese Patent Application Publication No. Hei 10-86081) (hereinafter referred to as “Background-Art Technique 3”).

However, according to the aforementioned method of Background-Art Technique 1, it takes much time for calculation due to considerably complicated processing. Thus, the method is not suitable for generation of locomotion in real time.

The aforementioned method of Background-Art Technique 2 is high-speed enough to generate locomotion in real time. However, it is necessary to calculate a trajectory for every several steps by batch processing. It is therefore necessary to pay attention to connection of the divided and calculated trajectories so as to prevent discontinuity among the trajectories. In addition, there is a problem that “unevenness” occurs till a change in the desired ZMP value is reflected.

Further, according to the aforementioned method of Background-Art Technique 3, it is necessary to prepare typical locomotion in advance. In addition, there is a problem that locomotion which can be generated is considerably limited.

It is an object of the present invention to provide a gait pattern generating device of a walking robot for generating locomotion in a simple manner, in which the foregoing problems are solved by generating a walking motion in real time, for example, using a previewed or planned future ZMP which will be obtained in a few seconds from now.

### DISCLOSURE OF THE INVENTION

In order to attain the foregoing object, a gait pattern generating device of a walking robot for generating a walking motion from a desired ZMP trajectory using ZMP preview information according to the present invention is characterized in that a driving quantity of the center of gravity in one moment is determined on the basis of a fed-back motion state of the center of gravity in that moment, and a previewed or planned future ZMP trajectory, so as to generate a walking motion in real time.

In addition, the gait pattern generating device of a walking robot using ZMP preview information according to the present invention is characterized in that the walking robot is a bipedal walking robot.

Further, the gait pattern generating device of a walking robot using ZMP preview information according to the present invention is characterized in that the previewed or planned future ZMP trajectory is corrected based on a detailed dynamical model of the robot in addition to a basic model using a table-cart model.

### BRIEF DESCRIPTION OF THE DRAWINGS

FIG. 1 is a block diagram showing generation of a trajectory based on preview control according to an embodiment of the present invention.

FIG. 2 is a graph showing a motion of the center of gravity calculated in a method according to the embodiment of the present invention, and a ZMP obtained as a result thereof.

FIG. 3 is a graph showing a preview control gain used in the embodiment of the present invention.

FIG. 4 is a graph showing a motion of the center of gravity calculated when the preview time is short, and a ZMP obtained as a result thereof.

FIG. 5 is a view showing a simulation in which a bipedal walking robot is walking.

FIG. 6 is a graph showing a difference between a ZMP (broken line) based on a table-cart model and a ZMP (thin solid line) based on a detailed model in which motions of limbs are also taken into consideration.

FIG. 7 is a diagram showing the configuration of a ZMP correction device based on preview control according to the embodiment of the present invention.

FIG. 8 is a graph showing a corrected ZMP trajectory based on the detailed model.

FIG. 9 is a view showing an example of a bipedal walking robot aimed at by the present invention.

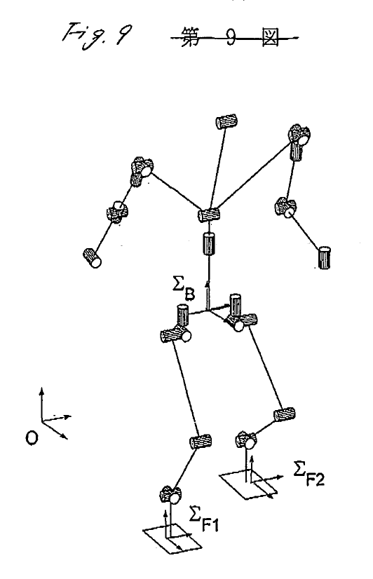

FIG. 10 is a view showing a table-cart model for approximating the dynamics of a bipedal walking robot.

### BEST MODE FOR CARRYING OUT THE INVENTION

The present invention will be described in more detail with reference to the accompanying drawings.

[Pattern Generation Based on Preview Control Rules]

First, Expression 2 is expressed as the following dynamic system with time-derivative of acceleration (jerk) of the waist as an input and a ZMP as an output.

$$\frac{d}{ⅆ t} [ \begin{matrix}x \\ {x}^{′} \\ {x}^{″}\end{matrix} ] = [ \begin{matrix}0 & 1 & 0 \\ 0 & 0 & 1 \\ 0 & 0 & 0\end{matrix} ] [ \begin{matrix}x \\ {x}^{′} \\ {x}^{″}\end{matrix} ] + [ \begin{matrix}0 \\ 0 \\ 1\end{matrix} ] u \\ p = [ 1 \; 0 - {z}_{h} / g ] [ \begin{matrix}x \\ {x}^{′} \\ {x}^{″}\end{matrix} ] \qquad ( 3 )$$

When this system is discretized with sampling time T, the following Expression 4 can be obtained.
Xₖ₊₁=Axₖ+Buₖ
Pₖ=Cxₖ (4)
where:
Xₖ≡(x(k*T)x′(k*T)x″(k*T})^{T}
Uₖ≡u(k*T)
pₖ≡p(k*T)

$$A ≡ [ \begin{matrix}1 & T & {T}^{2} / 2 \\ 0 & 1 & T \\ 0 & 0 & 1\end{matrix} ]$$

$$B ≡ [ \begin{matrix}{T}^{3} / 6 \\ {T}^{2} / 2 \\ T\end{matrix} ]$$

$$C ≡ [ 1 \; 0 - {z}_{h} / g ]$$

Assume that:
pₖ^{ref}
designates a desired ZMP trajectory of the output pₖ of Expression 4, and a performance function is provided by:

$$J = {\sum }_{j = 1}^{∞} \{ {Q ( {pj}^{ref} - pj )}^{2} + {Ruj}^{2} \} \qquad ( 5 )$$

where Q and R designates appropriate positive numbers. Consider a problem of how to minimize the performance function so as to allow the output pₖ to track the desired ZMP trajectory as correctly as possible.

According to the preview control theory proposed for the first time in “Hayase and Ichikawa: Optimal Servosystem Utilizing Future Value of Desired Function, Transactions of the Society of Instrument and Control Engineers, Vol.5, No.1, pp.86-94, (1969)”, a control input for minimizing the performance function of Expression 5 is provided by the following Expression 6.

$${u}_{k} = - {Kx}_{k} + [ {f}_{1} , {f}_{2} , . . . {f}_{N} ] [ \begin{matrix}{p}_{k + {1}^{ref}} \\ . \\ . \\ . \\ {p}_{k + {N}^{ref}}\end{matrix} ] \qquad ( 6 )$$

This expression shows that the driving quantity of the center of gravity in a moment is determined on the basis of the fed-back motion state of the center of gravity in that moment (the first term of the right side) and desired values up to the N-step future:
pₖ₊₁^{ref}, . . . , p_{k+N}^{ref}

This corresponds just to such a situation that a driver of a vehicle can drive the vehicle smoothly by turning a steering wheel while seeing a curve of a road ahead.

In this case, N corresponds to how far the driver sees the condition of the road. In addition, τ=N*T is called “preview time”, meaning the number of seconds in the future to take into account for control.

The characteristic of the preview control can be adjusted by the parameters Q and R in Expression 5. When the Q is made larger than the R, a motion of the waist with which the ZMP will coincide with the desired value as correctly as possible can be obtained. However, the motion of the waist will be a violent motion with a large differential value of acceleration. On the contrary, when the R is made larger than the Q, the motion of the waist will be smooth. However, the error of the ZMP from the desired trajectory will increase.

Incidentally, a feedback gain required for the preview control is calculated as follows.
K≡(R+B^{T}PB)⁻¹B^{T}PA
f₁≡(R+B^{T}PB)⁻¹B^{T}(A−BK)^{T}*^{(i-l)}C^{T}Q (7)
where P designates a solution of the following Riccati's equation:
P=A^{T}PA+C^{T}QC−A^{T}PB(R+B^{T}PB)⁻¹B^{T}PA (8)

When the method shown here is used, there is a problem that some offset error remains in the ZMP. This can be solved by introduction of correction described in “Egami and Tsuchiya: Optimal Preview Control and Generalized Preview Control, Instrument and Control, Vol. 39, No. 5, pp. 337-342 (2000)”.

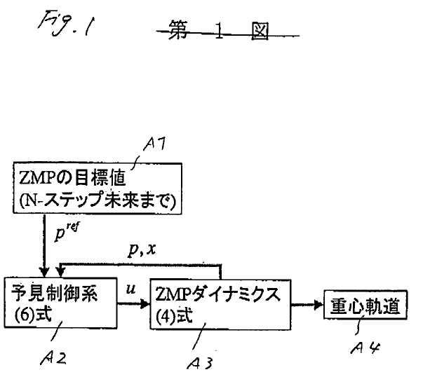

FIG. 1 shows a block diagram of trajectory generation based on preview control. Tacking on a desired value of the ZMP output is achieved by a preview control system. In that event, the state Xₖ₊₁ of Expression 4 calculated concurrently is a motion pattern of the center of gravity to be obtained.

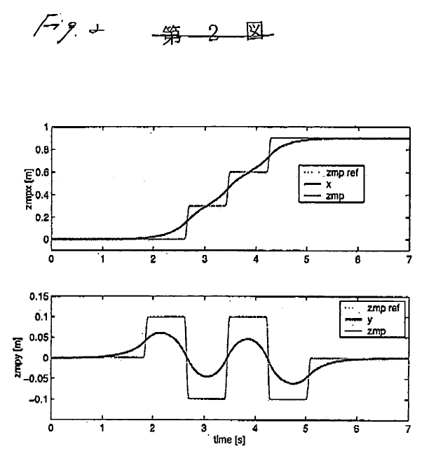

FIG. 2 shows a motion of the center of gravity calculated in a method according to the embodiment of the present invention, and a ZMP obtained as a result thereof. The upper graph of FIG. 2 shows a motion pattern in the traveling direction, and the lower graph of FIG. 2 shows a motion pattern in the left/right direction. It is understood that a proper motion of the center of gravity is generated in accordance with a step-like or rectangular desired ZMP in each pattern

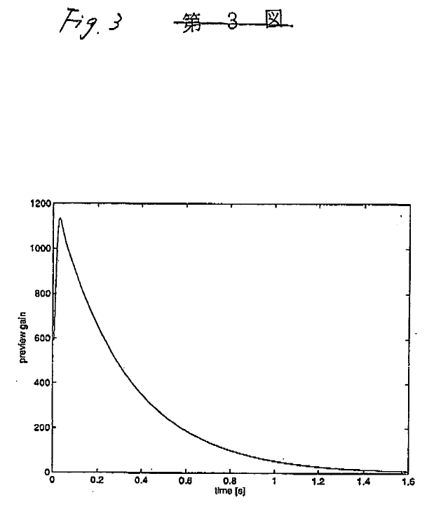

FIG. 3 shows a preview control gain used.

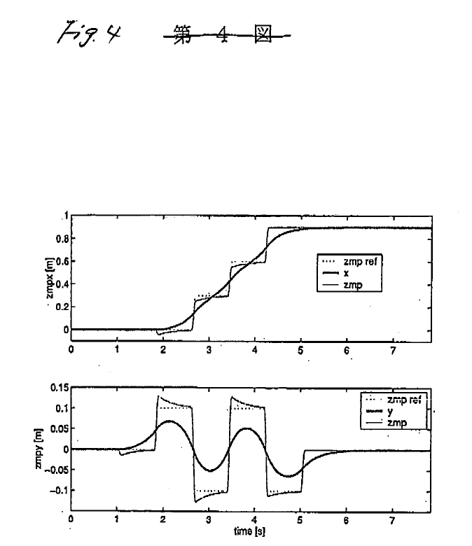

As is understood from FIG. 3, the gain at 1.6 s is so small that there will not appear a large change in control performance even if any desired value in the future from this time is used. Therefore, τ=1.6 (s) is used as preview time in FIG. 2. On the other hand, when the future preview interval is short, the control performance deteriorates. FIG. 4 shows a result when the preview time is set at τ=0.8 (s). It is understood that the stability is secured while the ZMP tracking performance deteriorates on a large scale.

In such a manner, according to this system, the ZMP up to a certain point of the future has to be decided. For example, in the case of a robot walking at an average of 2 km per hour, the preview time of 1.6 seconds corresponds to looking 0.89 m ahead. Meanwhile, it can be considered reasonable from our intuition that we cannot keep walking in peace without looking ahead to such an extent.

[Use for Correction of ZMP Error]

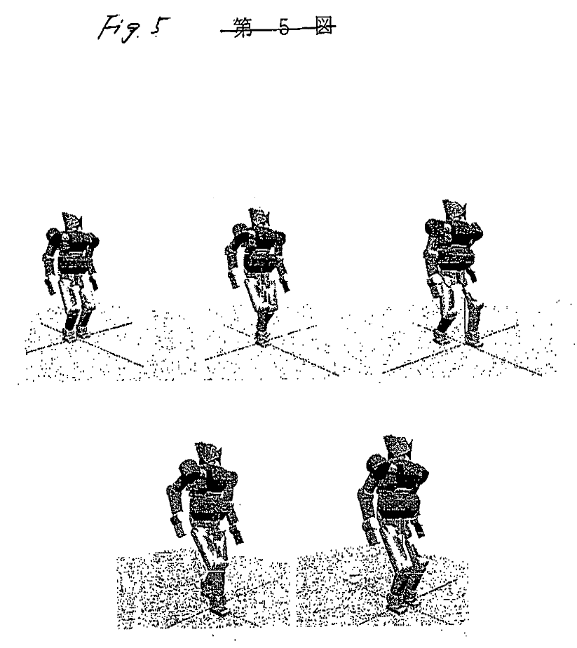

Desired walking can be attained by driving to allow the displacement of the center of gravity or the waist of the robot to coincide with the trajectory calculated in the aforementioned manner. FIG. 5 shows a simulation in which a bipedal walking robot weighing 62.5 kg is walking based on a calculated center-of-gravity trajectory.

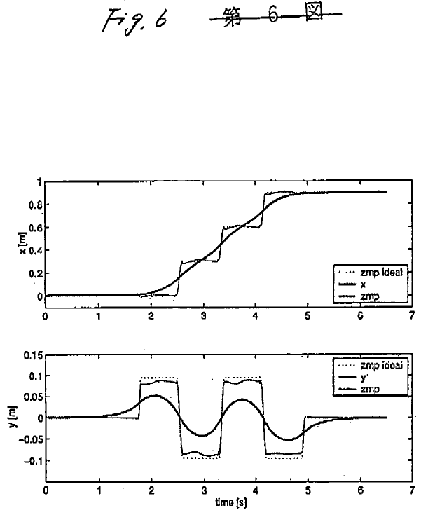

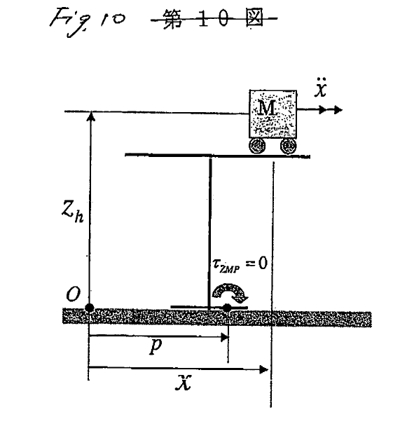

Here, the problem lies in the fact that there occurs an error in the ZMP because any accelerated/decelerated motion of any limb is left out of consideration in the table-cart model in FIG. 10. FIG. 6 shows a difference between a ZMP (broken line) based on the table-cart model and a ZMP (thin solid line) based on a detailed model in which motions of limbs are also taken into consideration.

There is a possibility that walking becomes unstable when the error of the ZMP increases. Quite the same method based on preview control can be used for correcting the error of the ZMP.

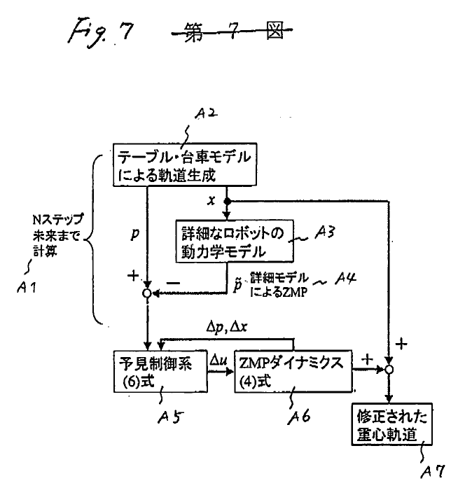

That is, it will go well if an expected ZMP error is calculated prior to walking of the robot, and a corrected value of the trajectory of the center of gravity is calculated based on the expected error. FIG. 7 shows the configuration of a ZMP correction device based on preview control according to the present invention.

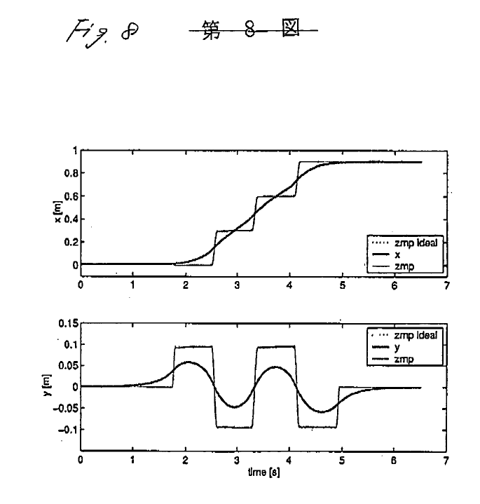

FIG. 8 shows a ZMP trajectory corrected thus on the basis of a detailed model. As is apparent from the drawing, it is understood that when preview control is used, a stable walking motion attaining a desired ZMP can be generated even in a robot having a complicated structure.

Incidentally, when preview control is used for correcting a ZMP error in such a manner, the corrected value is not so large. Therefore, it will go well if the preview time is short. In the example of FIG. 8, the preview time is set at τ=0.75 (s).

In comparison with the background art, the present invention has excellent effects as follows.

(1) As compared with Background-Art Technique 1, the speed is very high in the present invention because easy product-sum calculation based on Expression 6 is performed simply, while Background-Art Technique 1 needs Fourier transform and inverse Fourier transform.

(2) As compared with Background-Art Technique 2, the trajectory of the center of gravity can be obtained continuously every moment in the present invention so as to save the labor of calculating the trajectory every several steps and connecting the calculated trajectories as in Background-Art Technique 2. As a result, the program is simplified extremely.

(3) As compared with Background-Art Technique 3, typical locomotion does not have to be beforehand planned at all in the present invention. Thus, a proper trajectory of the center of gravity can be generated desirably only if a desired ZMP pattern is provided.

### INDUSTRIAL APPLICABILITY

Since the present invention is configured as described above, the present invention is suitable to a behavior generating device of a bipedal walking robot, a humanoid robot or the like for generating a walking motion in real time.

1. A gait pattern generating device of a walking robot for generating a gait pattern from a desired ZMP trajectory using ZMP preview information, wherein
a driving quantity of the center of gravity in one moment is determined on the basis of a fed-back motion state of the center of gravity in the moment and a previewed or planned future ZMP trajectory, so as to generate a walking motion in real time.

2. The gait pattern generating device of a walking robot using ZMP preview information according to claim 1, wherein the walking robot is a bipedal walking robot.

3. The gait pattern generating device of a walking robot using ZMP preview information according to claim 1 or 2, wherein
the previewed or planned future ZMP trajectory is corrected based on a detailed dynamical model of the robot in addition to a basic model using a table-cart model.
